(19) United States
(12) Patent Application Publication
(10) Pub. No.: US 2022/0085638 A1
(43) Pub. Date: Mar. 17, 2022

(54) CHARGE AND DISCHARGE CONTROL METHOD, CHARGE AND DISCHARGE CONTROL DEVICE, CONTROL SYSTEM, AND BATTERY-MOUNTED APPARATUS

(71) Applicant: KABUSHIKI KAISHA TOSHIBA, Tokyo (JP)

(72) Inventors: Tomoko SUGIZAKI, Kawasaki Kanagawa (JP); Tomoe KUSAMA, Tokyo (JP); Yuta KANAI, Tokyo (JP); Keigo HOSHINA, Yokohama Kanagawa (JP); Tetsuya SASAKAWA, Yokohama Kanagawa (JP); Ryosuke YAGI, Yokohama Kanagawa (JP); Yasuhiro HARADA, Isehara Kanagawa (JP); Norio TAKAMI, Yokohama Kanagawa (JP)

(73) Assignee: KABUSHIKI KAISHA TOSHIBA, Tokyo (JP)

(21) Appl. No.: 17/186,054

(22) Filed: Feb. 26, 2021

(30) Foreign Application Priority Data
Sep. 14, 2020 (JP) 2020-153902

(51) Int. Cl. H02J 7/00; H01M 10/44; H01M 10/46

(52) U.S. Cl. CPC H02J 7/007194; H01M 10/443; H02J 7/0013; H01M 10/46; H01M 10/441

(57) ABSTRACT

According to one embodiment, a storage battery includes one or more first batteries that include a first active material as a negative electrode active material, and one or more second batteries that include a second active material having an operation electric potential lower than that of the first active material as a negative electrode active material. Charge and the discharge of the second batteries are stopped based on a fact that a temperature of the storage battery is lower than a temperature threshold. The second batteries are caused to charge or discharge based on a fact that the temperature of the storage battery is equal to or higher than the temperature threshold.

### CROSS-REFERENCE TO RELATED APPLICATIONS

This application is based upon and claims the benefit of priority from Japanese Patent Application No. 2020-153902, filed Sep. 14, 2020; the entire contents of which are incorporated herein by reference.

### FIELD

Embodiments described herein relate generally to a charge and discharge control method, a charge and discharge control device, a control system, and a battery-mounted apparatus.

### BACKGROUND

In recent years, storage batteries have been mounted on battery-mounted apparatuses, such as smartphones, vehicles, stationary power supplies, robots, and drones. In some types of storage batteries to be mounted on a battery-mounted apparatus as described above, two or more kinds of batteries are combined, which respectively include active materials different from each other. For example, a type of storage battery is formed of a combination of a battery including a titanium oxide as a negative electrode active material and a battery including a carbonaceous material as a negative electrode active material. Furthermore, a control system has been developed, which is configured to control charge and discharge of the storage battery formed of two or more kinds of batteries.

In the control system as described above, even if the storage battery is charged rapidly with a large current, it is required that safety be secured by, for example, controlling the current to be input to each of the two or more kinds of the batteries to suppress precipitation of lithium metal in the negative electrodes of all batteries of the two or more kinds. Furthermore, in the control system, when the storage battery is discharged, it is required that the storage battery be able to continuously discharge for a long period of time by controlling outputs from the respective batteries of the two or more kinds.

### BRIEF DESCRIPTION OF THE DRAWINGS

FIG. 1 is a schematic diagram showing a control system according to a first embodiment.

FIG. 2A is a schematic diagram showing an example of points of a storage battery according to the first embodiment where a temperature is measured.

FIG. 2B is a schematic diagram showing an example of points of the storage battery according to the first embodiment, other than the example of FIG. 2A, where a temperature is measured.

FIG. 2C is a schematic diagram showing an example of a point of the storage battery according to the first embodiment, other than the examples of FIG. 2A and FIG. 2B, where a temperature is measured.

FIG. 2D is a schematic diagram showing an example of points of the storage battery according to the first embodiment, other than the examples of FIG. 2A to FIG. 2C, where a temperature is measured.

FIG. 3 is a flowchart illustrating an example of processing performed by a controller of a charge and discharge control device when the storage battery of the first embodiment is used.

FIG. 4 is a schematic diagram showing a control system according to a second embodiment.

FIG. 5 is a flowchart illustrating an example of processing performed by a controller of a charge and discharge control device when a storage battery of the second embodiment is used.

FIG. 6 is a schematic diagram showing a control system according to a modification of the second embodiment.

### DETAILED DESCRIPTION

Embodiments provide a charge and discharge control method of controlling charge and discharge of a storage battery, the storage battery including one or more first batteries that include a first active material as a negative electrode active material, and one or more second batteries that include a second active material having an operation electric potential lower than that of the first active material as a negative electrode active material. In the charge and discharge control method, charge and discharge of the second batteries are stopped based on the fact that the temperature of the storage battery is lower than a temperature threshold. In the charge and discharge control method, the second batteries are charged or discharged based on the fact that the temperature of the storage battery is equal to or higher than the temperature threshold.

Hereinafter, the embodiments will be described with reference to the accompanying drawings.

### First Embodiment

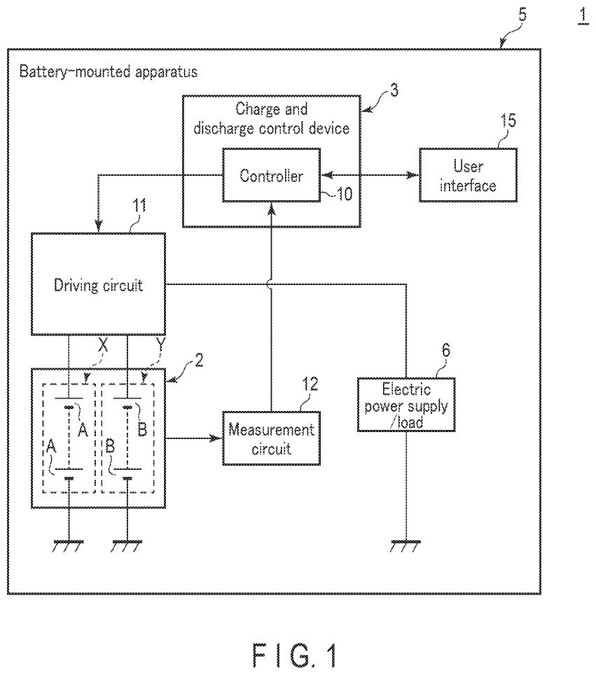

FIG. 1 shows a control system according to embodiments; specifically, a control system 1 according to a first embodiment as an example. As shown in FIG. 1, the control system 1 includes a storage battery 2 and a charge and discharge control device 3. The storage battery 2 is mounted on a battery-mounted apparatus 5. Examples of the battery-mounted apparatus 5 include a smartphone, a vehicle, a stationary power supply, a robot, and a drone. Examples of the vehicle as the battery-mounted apparatus 5 include an electric automobile, a plug-in hybrid automobile, an electric motorcycle, etc. Examples of the robot on which the storage battery 2 is mounted include a transfer robot such as an automated guided vehicle (AGV) for use in a factory or the like.

In this embodiment, the storage battery 2 includes one or more batteries (first batteries) A and one or more batteries (second batteries) B. In the example shown in FIG. 1, the storage battery 2 includes a plurality of batteries A and a plurality of batteries B. In the storage battery 2 of the example shown in FIG. 1, a battery module (first battery module) X is formed of all of the batteries A. In the battery module X, the batteries A are electrically connected in series. Furthermore, in the storage battery 2, a battery module (second battery module) Y is formed of all of the batteries B. In the battery module Y, the batteries B are electrically connected in series. At the start of use of the storage battery 2, all of the batteries A are the same or substantially the same in capacity, size, weight, etc. Also, at the start of use of the storage battery 2, all of the batteries B are the same or substantially the same in capacity, size, weight, etc.

Each of the batteries A and B may be a unit cell (unit battery) or may be a cell block in which a plurality of unit cells are electrically connected. If each of the batteries A and B is a cell block formed of a plurality of unit cells, the unit cells may be electrically connected in series or in parallel in each of the batteries A and B. Furthermore, each of the batteries A and B may include both a serial connection structure, in which the unit cells are electrically connected in series, and a parallel connection structure, in which the unit cells are electrically connected in parallel.

The unit cell is, for example, a battery cell constituting a lithium ion secondary battery. The unit cell includes an electrode group, and the electrode group includes a positive electrode and a negative electrode. In the electrode group, a separator is interposed between the positive electrode and the negative electrode. The separator is made of a material having electrical insulation properties, and electrically insulates the positive electrode from the negative electrode. The separator is, but is not limited to, a porous film or nonwoven fabric made of synthetic resin.

The positive electrode includes a positive electrode current collector such as a positive electrode current collecting foil, and a positive electrode active material-containing layer supported on a surface of the positive electrode current collector. The positive electrode current collector is, but is not limited to, for example, an aluminum foil or an aluminum alloy foil, and has a thickness of about 10 μm to 20 μm. The positive electrode active material-containing layer includes a positive electrode active material, and may optionally contain a binder and an electro-conductive agent. Examples of the positive electrode active material include, but are not limited to, oxides, sulfides, and polymers, which can absorb and release lithium ions. The positive electrode active material includes, for example, at least one selected from the group consisting of a manganese dioxide, an iron oxide, a copper oxide, a nickel oxide, a lithium-manganese composite oxide, a lithium-nickel composite oxide, a lithium-cobalt composite oxide, a lithium-nickel-cobalt composite oxide, a lithium-manganese-cobalt composite oxide, a spinel-type lithium-manganese-nickel composite oxide, a lithium-phosphorus oxide having an olivine structure, a ferric sulfate, and a vanadium oxide. The positive electrode current collector includes a positive electrode current collecting tab as a portion not supporting the positive electrode active material-containing layer.

The negative electrode includes a negative electrode current collector, such as a negative electrode current collecting foil, and a negative electrode active material-containing layer supported on a surface of the negative electrode current collector. The negative electrode current collector is, but is not limited to, for example, an aluminum foil, an aluminum alloy foil, or a copper foil, and has a thickness of about 10 μm to 20 μm. In the unit cell forming the battery (first battery) A, an aluminum foil or an aluminum alloy foil is preferably used as the negative electrode current collector. In the unit cell forming the battery (second battery) B, a copper foil is preferably used as the negative electrode current collector. The negative electrode active material-containing layer includes a negative electrode active material, and may optionally contain a binder and an electro-conductive agent. Examples of the negative electrode active material include, but are not limited to, metal oxides, metal sulfides, metal nitrides, and carbonaceous materials, which can absorb and release lithium ions. Examples of the metal oxides as the negative electrode active material include titanium-containing oxides. The titanium-containing oxides as the negative electrode active material include, for example, a titanium oxide, a lithium-titanium-containing composite oxide, a niobium-titanium-containing composite oxide, and a sodium-niobium-titanium-containing composite oxide. Examples of the carbonaceous materials as the negative electrode active material include graphite or the like. The negative electrode current collector includes a negative electrode current collecting tab as a portion not supporting the negative electrode active material-containing layer.

In the unit cell forming the battery (first battery) A, a first active material is used as the negative electrode active material. In the unit cell forming the battery (second battery) B, a second active material having an operation electric potential lower than that of the first active material is used as the negative electrode active material. In one example, an active material having an operation electric potential of 0.4 V (vs. Li/Li⁺) or more is used as the first active material, and an active material having an operation electric potential less than 0.4 V (vs. Li/Li⁺) is used as the second active material. In this case, for example, any kind of titanium-containing oxide can be used as the first active material, and any kind of carbonaceous materials can be used as the second active material. Since the operation electric potential of the second active material is lower than the operation electric potential of the first active material, the negative electrode potential of the unit cell forming the battery B is lower than the negative electrode potential of the unit cell forming the battery A, if the conditions other than the kind of the negative electrode active materials are the same.

In the electrode group, the positive electrode, the negative electrode, and the separator are wound around a winding axis with the separator sandwiched between the positive electrode active material-containing layer and the negative electrode active material-containing layer. Thus, the electrode group has a wound structure. In another example, the electrode group has a stack structure in which a plurality of positive electrodes and a plurality of negative electrodes are alternately stacked, and a separator is provided between the positive electrode and the negative electrode.

Furthermore, in the unit cell, the electrode group holds (is impregnated with) an electrolytic solution. The electrolytic solution may be a nonaqueous electrolytic solution obtained by dissolving an electrolyte in an organic solvent, or may be an aqueous electrolytic solution such as an aqueous solution obtained by dissolving an electrolyte in an aqueous solvent.

Furthermore, a gel electrolyte obtained by combining an electrolytic solution with a polymeric material may be used instead of the electrolytic solution. Instead of the electrolytic solution or in addition to the electrolytic solution, a solid electrolyte may be used. If a solid electrolyte is used as the electrolyte, the solid electrolyte may be interposed between the positive electrode and the negative electrode instead of the separator in the electrode group. In this case, the positive electrode is electrically insulated from the negative electrode by the solid electrolyte.

Moreover, in the unit cell, the electrode group is housed in a container member. A sack-shaped container made of laminated film or a metallic container can be used as the container member. For example, a multilayer film is used as the laminated film, and the multilayer film includes a plurality of resin layers and a metal layer disposed between the resin layers. The thickness of the laminated film is preferably 0.5 mm or less, more preferably 0.2 mm or less. The metallic container is preferably formed of, for example, at least one metal selected from the group consisting of aluminum, zinc, titanium, and iron, or an alloy of these metals. The metallic container preferably has a wall thickness of 0.5 mm or less, and more preferably 0.2 mm or less.

The unit cell includes a pair of electrode terminals. One of the electrode terminals is a positive electrode terminal electrically connected to the positive electrode current collecting tab. The other of the electrode terminals that is not the positive electrode terminal is a negative electrode terminal electrically connected to the negative electrode current collecting tab. The electrode terminals may be internal terminals formed inside the container member, or may be external terminals formed outside the container member. Each of the electrode terminals is formed of an electro-conductive material that is at least one metal selected from the group consisting of aluminum, zinc, titanium, and iron, or an alloy of these metals.

Since the batteries A and B are formed individually as described above, the negative electrode active materials in the batteries A and B are different from each other. Specifically, in the battery A, the first active material having a relatively high operation electric potential, such as a titanium-containing oxide, is used as the negative electrode active material. In the battery B, the second active material having an operation electric potential lower than that of the first active material, such as a carbonaceous material, is used as the negative electrode active material. As described above, since the negative electrode active materials in the batteries A and B are different from each other, even when the battery (first battery) A is charged rapidly with a large current, lithium metal or the like does not precipitate in the negative electrode. In contrast, when the battery (second battery) B is charged rapidly with a large current, in particular under a low-temperature environment, lithium metal or the like is likely to precipitate in the negative electrode.

In addition, the battery A is able to discharge with a larger current as compared to the battery B, and has a higher output performance as compared to the battery B. Particularly, when used under a low-temperature environment, the difference in output performance between the batteries A and B is noticeable. On the other hand, the battery B has a larger capacity as compared to the battery A. Therefore, when used under an environment in which the temperature is increased to a certain degree from the low-temperature environment, the battery B is capable of continuously discharging for a longer period of time as compared to the battery A.

As shown in FIG. 1, the control system 1 includes an electric power supply and load (denoted by a reference symbol 6). The electric power supply is configured to supply electric power to the storage battery 2 (batteries A and B), and the storage battery 2 is supplied with electric power from the electric power supply and thereby charges. The load is configured to be supplied with electric power from the storage battery 2 (batteries A and B), and the storage battery 2 supplies electric power to the load or the like and thereby discharges. Examples of the electric power supply include a battery other than the storage battery 2, and an electricity generator or the like. Examples of the load include an electric motor, a light, or the like. In one example, instead of the load or in addition to the load, a capacitor supplied with electric power from the storage battery 2 may be provided. In this case, the storage battery 2 discharges by supplying electric power to the capacitor. The capacitor is configured to store electric power supplied from the storage battery 2. In another example, a motor generator may be provided. In this case, electric power can be supplied from the storage battery 2 to the motor generator, and electric power can also be supplied from the motor generator to the storage battery 2. Thus, the motor generator functions as both the electric power supply and the load. In the example shown in FIG. 1, the electric power supply and load is mounted in the battery-mounted apparatus 5; however, the embodiment is not limited to this configuration. The storage battery 2 may be configured to supply electric power to a load outside the battery-mounted apparatus 5, or the storage battery 2 may be configured to be supplied with electric power from an electric power supply outside the battery-mounted apparatus 5.

The charge and discharge control device 3 controls charge and discharge of the storage battery 2. The charge and discharge control device 3 includes a controller 10. In the example shown in FIG. 1, the charge and discharge control device 3 is mounted on the battery-mounted apparatus 5, and constitutes a processing device (computer) in the battery-mounted apparatus 5. The controller 10 of the charge and discharge control device 3 includes a processor and a storage medium. The processor includes any of a central processing unit (CPU), a graphics processing unit (GPU), an application specific integrated circuit (ASIC), a microcomputer, a field programmable gate array (FPGA), digital signal processor (DSP), etc. The storage medium may include a main storage device, such as a memory, and an auxiliary storage device. Examples of the storage medium include a magnetic disk, an optical disk (CD-ROM, CD-R, DVD, etc.), a magnetic optical disk (MO etc.), a semiconductor memory, etc. The controller 10 may include one or more processors, and one or more storage media. In the controller 10, the processor performs processing by executing a program or the like stored in the storage medium or the like. The program executed by the processor of the controller 10 may be stored in a computer (server) connected to the controller via a network, such as the Internet, or in a server or the like in a cloud environment. In this case, the processor downloads the program via the network.

The charge and discharge control device 3 may be provided outside the battery-mounted apparatus 5. In this case, the charge and discharge control device 3 is, for example, a server outside the battery-mounted apparatus 5, and is capable of communicating with the processing device (computer) mounted in the battery-mounted apparatus 5. In this case also, the controller 10 in the charge and discharge control device 3 includes a processor and a storage medium. Furthermore, the processing of the controller 10 in the charge and discharge control device 3 may be performed by the processing device mounted in the battery-mounted apparatus 5 and a server (processing device) outside the battery-mounted apparatus 5 in cooperation. In this case, for example, the server outside the battery-mounted apparatus 5 serves as a master control device, and the processing device mounted in the battery-mounted apparatus 5 serves as a slave control device. In another example, the processing of the controller 10 in the charge and discharge control device 3 may be performed by a cloud server constituted in a cloud environment. The infrastructure of the cloud environment is constituted by a virtual processor, such as a virtual CPU, and a cloud memory. Therefore, when the cloud server functions as the controller 10, the processing is performed by the virtual processor and data or the like necessary for the processing is stored in the cloud memory. Alternatively, the processing of the controller 10 may be performed by the processing device mounted in the battery-mounted apparatus 5 and the cloud server in cooperation. In this case, the processor (computer) mounted in the battery-mounted apparatus 5 is capable of communicating with the cloud server.

The control system 1 includes a driving circuit 11. The controller 10 controls driving of the driving circuit 11, thereby controlling supply of electric power from the storage battery 2 to the load, as well as supply of electric power from the electric power supply to the storage battery 2. In other words, the controller 10 controls driving of the driving circuit 11, thereby controlling charge and discharge of the storage battery 2 (batteries A and B). The driving circuit 11 includes a relay circuit configured to switch whether or not electric-power output from the storage battery 2 and whether or not electric-power input to the storage battery 2. The driving circuit 11 also includes a conversion circuit. The conversion circuit converts electric power from the electric power supply into direct-current electric power to be supplied to the storage battery 2. The conversion circuit also converts direct-current electric power from the storage battery 2 into electric power to be supplied to the load. The conversion circuit can include a voltage transformer circuit, a DC/AC conversion circuit, an AC/DC conversion circuit, and the like. The conversion circuit can include a DC/DC conversion circuit (DC/DC converter) which performs conversion between a direct-current electric power of a voltage suited to the batteries A and a direct-current electric power of a voltage suited to the batteries B.

According to this embodiment, a current input to the batteries A (the battery module X), an output from the batteries A (the battery module X), etc. are controlled by controlling the driving of the driving circuit 11. Furthermore, a current input to the batteries B (the battery module Y), an output from the batteries B (the battery module Y), etc. are controlled by controlling the driving of the driving circuit 11. In addition, according to this embodiment, by controlling the driving of the driving circuit 11, the battery module X can be switched only between a state in which charge and discharge are performed in all of the batteries A and a state in which charge and discharge are stopped in all of the batteries A. Also, by controlling the driving of the driving circuit 11, the battery module Y can be switched only between a state in which charge and discharge are performed in all of the batteries B and a state in which charge and discharge are stopped in all of the batteries B.

The control system 1 further includes a measurement circuit 12. The measurement circuit 12 detects and measures parameters relating to the storage battery 2. As the parameters relating to the storage battery 2, the measurement circuit 12 measures any of a current flowing through the battery module X (the batteries A), a current flowing through the battery module Y (the batteries B), a voltage of each of the batteries A and B, and a voltage of each of the battery modules X and Y. The measurement circuit 12 also measures a temperature T of the storage battery 2 as the parameters relating to the storage battery 2. The measurement circuit 12 includes one or more temperature sensors that measure temperatures. The measurement circuit 12 measures temperatures at one or more points in the storage battery 2 using the temperature sensors. The measurement circuit 12 determines, as a temperature T of the storage battery 2, one of a measurement value of the temperature at one point in the storage battery 2, a lowest value of measurement values of the temperatures at a plurality of points in the storage battery 2, and an average value or an intermediate value of measurement values of the temperatures at a plurality of points in the storage battery 2.

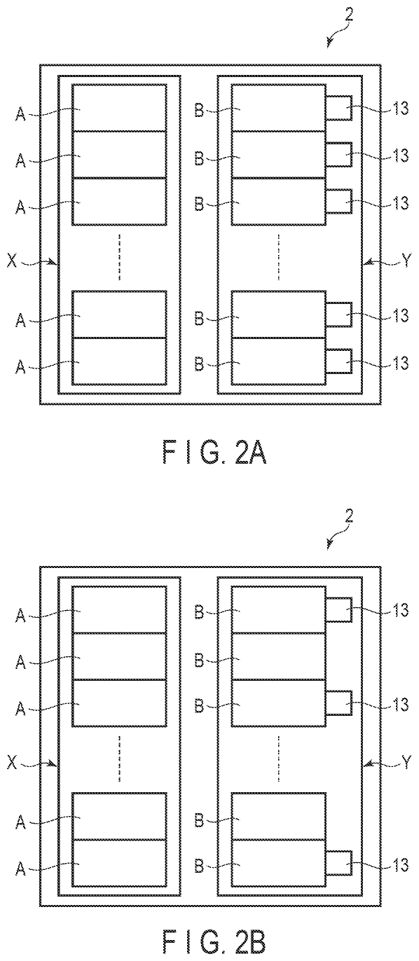

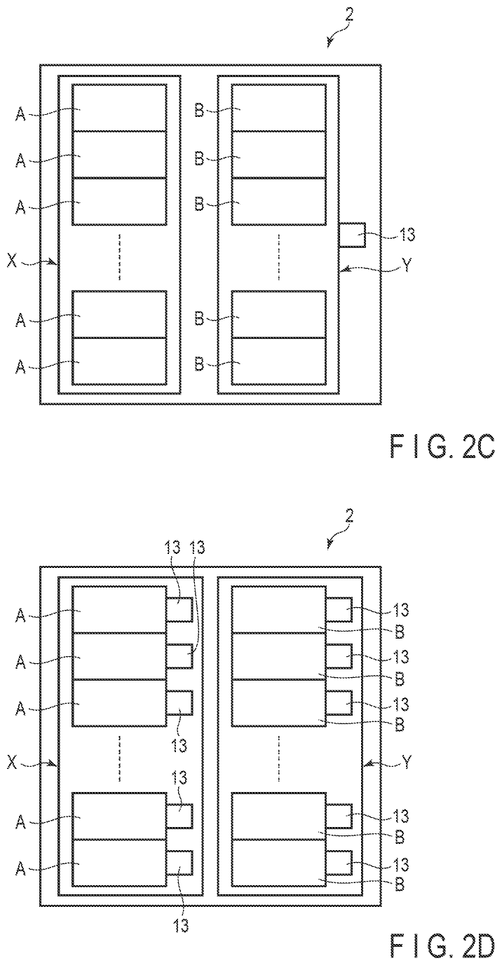

In the storage battery 2, the temperature of at least a region where the batteries (the second batteries) B are located is preferably measured. Furthermore, in the storage battery 2, the temperature of a region where the batteries (the first batteries) A are located may be measured, in addition to the region where the batteries (the second batteries) B are located. FIG. 2A to FIG. 2D shows examples of the points where the temperature is measured in the storage battery 2. In the example shown in FIG. 2A, temperature sensors 13 are arranged in only the region where the batteries B are located (the battery module Y). The number of the temperature sensors 13 is the same as the number of the batteries B; thus, the temperatures of all of the batteries B are measured by the temperature sensors 13. Also in the example shown in FIG. 2B and the example shown in FIG. 2C, the temperature sensors 13 are arranged in only the region where the batteries B are located (the battery module Y). However, in the example shown in FIG. 2B, the temperatures of only some of the batteries B are measured by the temperature sensors 13. In the example shown in FIG. 2C, the temperatures of the batteries B are not individually measured, but the temperature of the battery module Y as a whole is measured by the temperature sensor 13.

In the example shown in FIG. 2D, the temperature sensors 13 are arranged in not only the region where the batteries (the second batteries) B are arranged but also the region where the batteries (the first batteries) A are located. In the example shown in FIG. 2D, the temperatures of all of the batteries B are measured by the temperature sensors 13, and in addition, the temperatures of all of the batteries A are measured by the temperature sensors 13. In one example, the temperatures of only some of the batteries A may be measured by the temperature sensors 13. In another example, the temperatures of the batteries A are not individually measured, but the temperature of the battery module X as a whole may be measured by the temperature sensor 13. The arrangement of the temperature sensors 13 in the storage battery 2 is not limited to the examples described above; that is, the temperature sensors 13 may be arranged in any suitable positions in the storage battery 2. In any case, however, the temperature T of the storage battery 2 is obtained as a parameter T relating to the storage battery 2 based on measurement values of temperatures at one or more points in the storage battery 2. Alternatively, in one example, either a temperature outside the storage battery 2 in the battery-mounted apparatus 5, such as a vehicle, or a temperature of an environment where the battery-mounted apparatus 5 is used, may be obtained as a temperature T of the storage battery 2, so that the subsequent processing may be performed based on the temperature T.

The controller 10 acquires measurement results of parameters relating to the storage battery 2 including the temperature T. The measurement of the parameters relating to the storage battery 2, such as the temperature T, is periodically performed at predetermined timings. Therefore, the controller 10 periodically acquires the measurement results of the parameters, such as the temperature T. The controller 10 controls charge and discharge of the storage battery 2 based on the measurement results of the parameters relating to the storage battery 2, including the temperature T. The storage medium, the cloud memory, or the like of the controller 10 stores a temperature threshold Tth relating to the temperature T of the storage battery 2. The controller 10 controls the driving of the driving circuit 11 based on the temperature T and the temperature threshold Tth, thereby controlling the charge and the discharge of the storage battery 2. The temperature threshold Tth preferably falls within a range of values from −40° C. to 10° C.

In the control system 1, a user interface 15 is mounted on the battery-mounted apparatus 5. The user interface 15 functions as an operation device to which a user or the like of the battery-mounted apparatus 5 inputs an operation command, etc., and a notification device that notifies the user or the like of information. The user interface 15 includes any of a button, a dial, a touch panel, and the like, as an operation device, and the controller 10 performs processing based on an operation command input through the user interface 15. The controller 10 also gives notification of information through the user interface 15. The user interface 15 gives notification of the information through any of a screen display, a sound, etc.

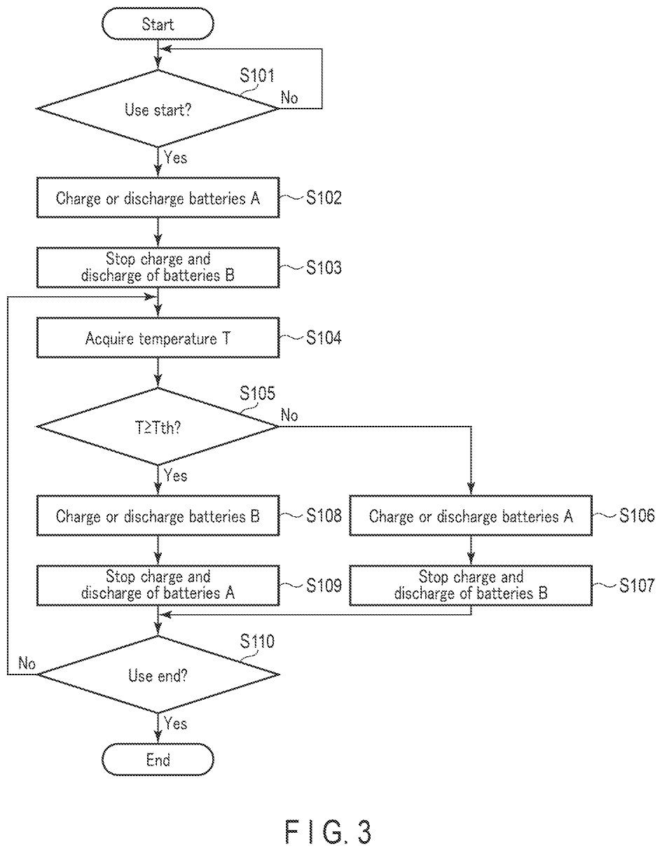

FIG. 3 shows an example of the processing performed by the controller 10 when the storage battery 2 is used. As shown in FIG. 3, if the controller 10 determines that the use of the storage battery 2 is started in S101 (S101—Yes), the controller 10 causes only the batteries (the first batteries) A to charge or discharge (S102), and maintains a state in which the charge and the discharge of all of the batteries (the second batteries) B are stopped (S103). As a result, input or output of electric power is performed only in the battery module X, and the input and the output of electric power are stopped in the battery module Y. In the battery module X, charge or discharge is performed in all of the batteries A, and in the battery module Y, charge and discharge are stopped in all of the batteries B.

Then, the controller 10 acquires a temperature T of the storage battery 2 (S104). The controller 10 determines whether the acquired temperature T is equal to or higher than the temperature threshold Tth (S105). If the temperature T is lower than the temperature threshold Tth (S105—No), the controller 10 causes only the batteries A (the battery module X) to charge or discharge (S106) in the same manner as in the process of S102, and stops the charge and the discharge of the batteries B (the battery module Y) (S107) in the same manner as in the process of S103. As a result, in the same manner as at the time of and immediately after the start of the use of the storage battery 2, input or output of electric power is performed in only the battery module X, and the input and the output of electric power are stopped in the battery module Y. If it is determined that the use of the storage battery 2 is not ended (S110—No), the process returns to S104. Then, the controller 10 successively executes the process of S104 and the subsequent processes.

In S105, if the temperature T is equal to or higher than the temperature threshold Tth (S105—Yes), the controller 10 causes only the batteries (the second batteries) B to charge or discharge (S108), and stops the charge and the discharge of the batteries (the first batteries) A (S109). As a result, input or output of electric power is performed in only the battery module Y, and the input and the output of electric power are stopped in the battery module X. Then, the battery module Y is brought to the state in which charge or discharge is performed in all of the batteries B, and the battery module X is brought to the state in which charge and discharge are stopped in all of the batteries A. If it is determined that the use of the storage battery 2 is not ended (S110—No), the process returns to S104. Then, the controller 10 successively executes the process of S104 and the subsequent processes.

Since the processing described above is performed, according to the present embodiment, the controller 10 stops the charge and the discharge of the batteries (the second batteries) B based on the fact that the temperature T of the storage battery 2 is lower than the temperature threshold Tth. Therefore, in the state in which the storage battery 2 is charged or discharged under a low-temperature environment, the input and the output of electric power in the batteries B (the battery module Y) are stopped. Thus, in the state in which the storage battery 2 is charged or discharged under a low-temperature environment, each of the batteries B is efficiently prevented from being charged with a large current, and precipitation of lithium metal or the like in the negative electrode in each of the batteries B is efficiently prevented. Accordingly, safety is assured when the storage battery 2 is charged with a large current under a low-temperature environment or the like.

Furthermore, in the present embodiment, the controller 10 causes the batteries (the second batteries) B to charge or discharge based on the fact that the temperature T is equal to or higher than the temperature threshold Tth of the storage battery 2. Therefore, in the state in which the storage battery 2 is used under an environment in which the temperature is increased to a certain degree from the low-temperature environment, electric power is output from each of the batteries B. Since discharge is performed from each of the batteries B having a large capacity, when the storage battery 2 is used under an environment in which the temperature is increased to a certain degree from the low-temperature environment, continuous discharge from the storage battery 2 is possible for a long period of time. For example, if the battery-mounted apparatus 5 in which the storage battery 2 is mounted is a vehicle, the vehicle can travel for a long period of time since continuous discharge from the storage battery 2 is possible for a long period of time.

Furthermore, in the present embodiment, if the temperature T of the storage battery 2 is lower than the temperature threshold Tth, the controller 10 causes the batteries (the first batteries) A to charge or discharge. Therefore, in the state in which the storage battery 2 is charged or discharged under a low-temperature environment, electric power is input or output in the batteries A (the battery module X). In each of the batteries A, even when charged with a large current under a low-temperature environment, lithium metal or the like cannot precipitate in the negative electrode. Furthermore, each of the batteries A can be discharged with a large current under a low-temperature environment. Therefore, even when the battery 2 is used under a low-temperature environment, input characteristics and output characteristics in the storage battery 2 are assured.

In addition, according to the present embodiment, after the use of the storage battery 2 is started and before a first determination based on the temperature threshold Tth is carried out, the controller 10 stops the charge and the discharge of the batteries (the second batteries) B. Actually, the storage battery 2 in which the aforementioned charge and discharge control is performed is low in temperature at the time of and immediately after the start of use of the storage battery 2. Thus, since charge and discharge of the batteries B are stopped at the time of and immediately after the start of use of the storage battery 2, the precipitation of lithium metal in the negative electrode of each of the batteries B can be prevented more efficiently. Accordingly, the safety is further improved when the storage battery 2 is charged with a large current under a low-temperature environment or the like.

### Modification of First Embodiment

In a modification of the first embodiment, if the temperature T is equal to or higher than the temperature threshold Tth (S105—Yes), the controller 10 may cause both the batteries (the first batteries) A and the batteries (the second batteries) B to charge or discharge instead of the processes of S108 and S109. In this case, the batteries A are charged or discharged regardless of whether or not the temperate T of the storage battery 2 is equal to or higher than the temperature threshold Tth. In this modification also, charge and discharge of the batteries B are stopped based on the fact that the temperature T of the storage battery 2 is lower than the temperature threshold Tth, and the batteries B are charged or discharged based on the fact that the temperature T of the storage battery 2 is equal to or higher than the temperature threshold Tth. Therefore, the present modification also exhibits similar effects and advantages to those of the first embodiment.

### Second Embodiment

A second embodiment will be explained next. In the following, explanations of the similar configurations and processes to those in the first embodiment will be omitted.

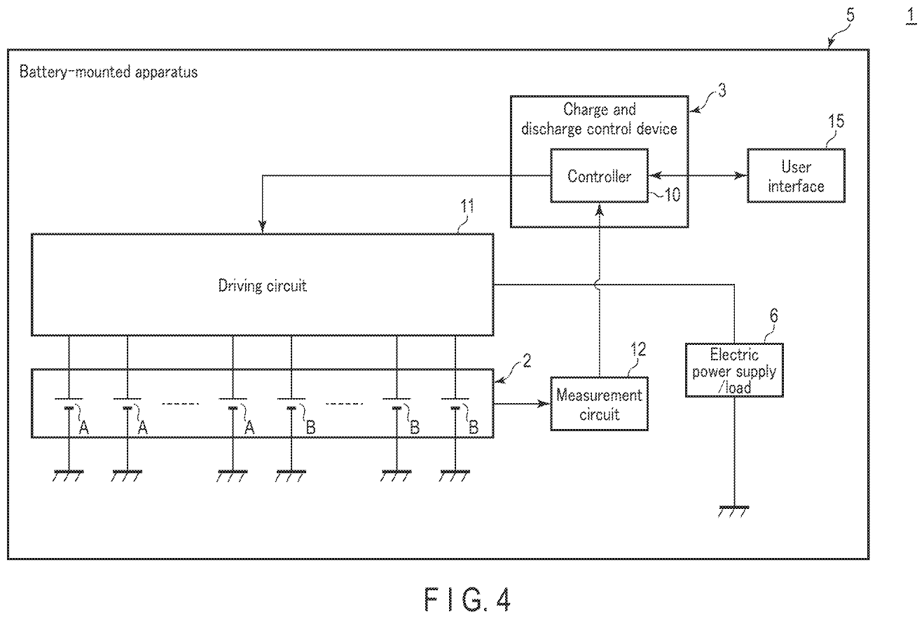

FIG. 4 shows a control system 1 according to the second embodiment. As shown in FIG. 4, in the same manner as in the first embodiment, the control system 1 of this embodiment includes a storage battery 2 and a charge and discharge control device 3, and the charge and discharge control device 3 includes a controller 10. The storage battery 2 is mounted on a battery-mounted apparatus 5. As in the first embodiment, the control system 1 includes an electric power supply and load (denoted by a reference symbol 6), a driving circuit 11, a measurement circuit 12, and a user interface 15. In the present embodiment, the storage battery 2 includes a plurality of batteries (first batteries) A and a plurality of batteries (second batteries) B.

Furthermore, in the present embodiment, the controller 10 controls the batteries A independently of each other regarding charge and discharge, and controls the batteries B independently of each other regarding charge and discharge. Therefore, the controller 10 can charge or discharge only some of the batteries A, and stop charge and discharge of the remainders of the batteries A by controlling driving of the driving circuit 11. Similarly, the controller 10 can charge or discharge only some of the batteries B, and stop charge and discharge of the remainders of the batteries B by controlling driving of the driving circuit 11.

In this embodiment, the measurement circuit 12 measures a temperature Tb of each of the batteries B as parameters relating to the storage battery 2. For example, the measurement circuit 12 includes temperature sensors of an equal number to the number of the batteries B; thus, the temperatures Tb of all of the batteries B are measured by the temperature sensors. The controller 10 acquires the measurement results of the temperature Tb of each of the batteries B. The measurement of the temperature Tb is periodically performed at predetermined timings. Therefore, the controller 10 periodically acquires the measurement results of the temperature Tb of each of the batteries B. In this embodiment, the controller 10 controls the driving of the driving circuit 11 based on the temperature Tb of each of the batteries B and the temperature threshold Tth, thereby controlling the charge and the discharge of the storage battery 2.

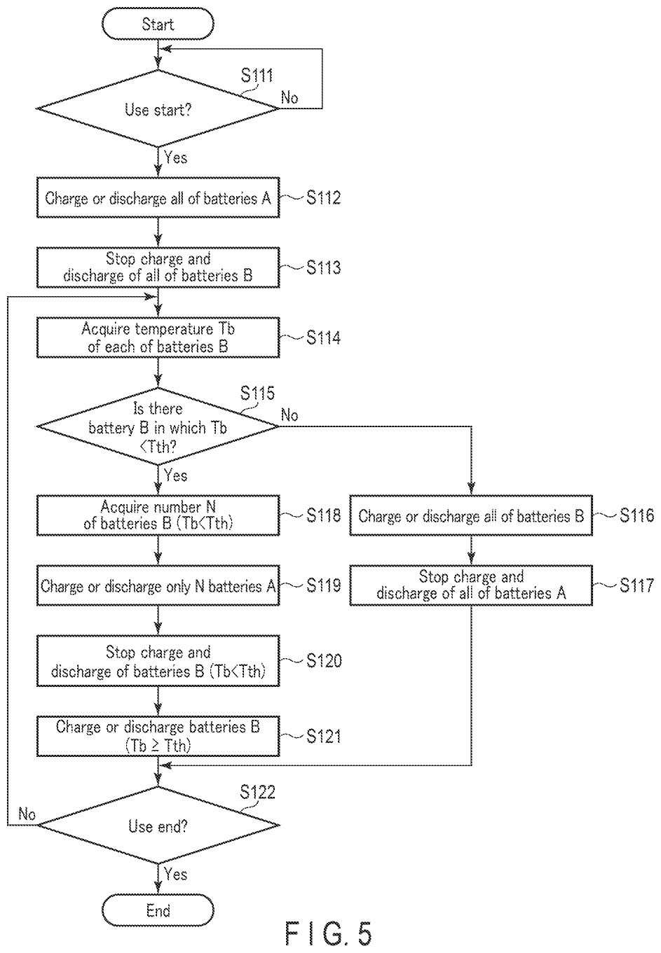

FIG. 5 shows an example of the processing performed by the controller 10 when the storage battery 2 is used. As shown in FIG. 5, if the controller 10 determines that the use of the storage battery 2 is started in S111 (S111—Yes), the controller 10 causes all of the batteries (the first batteries) A to charge or discharge (S112), and maintains a state in which the charge and the discharge of all of the batteries (the second batteries) B are stopped (S113). As a result, at the time of and immediately after the start of the use of the storage battery 2, input or output of electric power is performed in all of the batteries A, and the input and the output of electric power are stopped in all of the batteries B.

Then, the controller 10 acquires the temperature Tb of each of the batteries B (S114). The controller 10 determines whether, of the batteries B, there is a battery B having a temperature Tb acquired by the controller 10 that is lower than the temperature threshold Tth (S115). If there is no battery B having a temperature Tb lower than the temperature threshold Tth (S115—No), the controller 10 causes all of the batteries B to charge or discharge (S116), and stops the charge and the discharge of all of the batteries A (S117). In other words, if the temperature Tb is equal to or higher than the temperature threshold Tth in all of the batteries (the second batteries) B, the controller 10 stops the charge and the discharge of the batteries (the first batteries) A and causes all of the batteries B to charge or discharge. As a result, the input and the output of electric power are stopped in all of the batteries A, and the input or the output of electric power is performed in all of the batteries B. In S122, if it is determined that the use of the storage battery 2 is not ended (S122—No), the process returns to S114. Then, the controller 10 successively executes the process of S114 and the subsequent processes.

In S115, if there are one or more batteries B having a temperature Tb lower than the temperature threshold Tth (S115—Yes), the controller 10 acquires the number N of the batteries (the second batteries) B having a temperature Tb lower than the temperature threshold Tth (S118). The controller 10 causes the batteries A of the number N to charge or discharge (S119). At this time, when the storage battery 2 is charging, the controller 10 causes N batteries A out of all batteries A to charge sequentially, for example, in ascending order of a state of charge (SOC). When the storage battery 2 is discharging, the controller 10 causes N batteries A out of all batteries A to discharge sequentially, for example, in descending order of the SOC. The SOC of each of the batteries A may be calculated based on a time-dependent change of a current, by a current integrating method or the like, may be calculated based on the relationship between a voltage and an SOC, or may be calculated by an operation using a Kalman filter.

If there are one or more batteries B having a temperature Tb lower than the temperature threshold Tth (S115—Yes), the controller 10 stops the charge and the discharge of the N batteries B having a temperature Tb lower than the temperature threshold Tth (S120), and causes the remainders of the batteries B having a temperature Tb equal to or higher than the temperature threshold Tth to charge or discharge (S121). As a result of the processes in S118 to S121, the charge and the discharge are stopped in some or all (N) of the batteries B. Then, out of all of the batteries (the first batteries) A, only batteries A of an equal number N to the batteries (the second batteries) B, in which the charge and the discharge are stopped, are charged or discharged. As a result, in the batteries B having a temperature Tb equal to or greater than the temperature threshold Tth, input or output of electric power is performed, and in the batteries B having a temperature Tb lower than the temperature threshold Tth, the input and the output of electric power are stopped. In only N batteries A out of all batteries A, input or output of electric power is performed.

If a temperature Tb is lower than the temperature threshold Tth in all of the batteries B, the controller 10 stops the charge and the discharge of all of the batteries B. In this case, if the batteries A and the batteries B are the same in number, the controller 10 causes all of the batteries (the first batteries) A to charge or discharge. In step S122, if it is determined that the use of the storage battery 2 is not ended (S122—No), the process returns to S114. Then, the controller 10 successively executes the process of S114 and the subsequent processes.

Since the processing described above is performed, according to the present embodiment, the controller 10 stops the charge and the discharge of each of the batteries (the second batteries) B based on the fact that the temperature Tb is lower than the temperature threshold Tth. Therefore, each of the batteries B is efficiently prevented from being charged and discharged under a low-temperature environment. Thus, even if the storage battery 2 is charged or discharged under the low temperature environment, each of the batteries B is efficiently prevented from being charged with a large current, and precipitation of lithium metal or the like in the negative electrode in each of the batteries B is efficiently prevented. Accordingly, in the same manner as in the first embodiment etc., safety is assured when the storage battery 2 is charged with a large current under a low-temperature environment or the like.

Furthermore, in the present embodiment, the controller 10 causes each of the batteries (the second batteries) B to charge or discharge based on the fact that the temperature Tb is equal to or higher than the temperature threshold Tth. Therefore, each of the batteries B outputs electric power in the state of being used under an environment in which the temperature is increased to a certain degree from the low-temperature environment. Since discharge is performed from each of the batteries B having a large capacity, when the storage battery 2 is used under an environment in which the temperature is increased to a certain degree from the low-temperature environment, continuous discharge from the storage battery 2 is possible for a long period of time as in the first embodiment etc.

Furthermore, in the present embodiment, if the temperature Tb of some or all of the batteries B is lower than the temperature threshold Tth, the controller 10 causes the batteries A of an equal number N to the batteries B having a temperature Tb lower than the temperature threshold Tth to charge or discharge. In other words, electric power is input or output in the batteries A of an equal number N to the batteries B in which the input and the output of electric power are stopped. As described above, in each of the batteries A, even when charged with a large current under a low-temperature environment, lithium metal or the like cannot precipitate in the negative electrode. Furthermore, each of the batteries A can be discharged with a large current under a low-temperature environment. Therefore, even when the storage battery 2 is used under a low-temperature environment, input characteristics and output characteristics in the storage battery are assured as in the first embodiment.

Furthermore, instead of the batteries B in which the input and the output of electric power are stopped, the batteries A of an equal number N to the batteries B in which the temperature Tb is lower than the temperature threshold Tth are charged or discharged. In other words, out of all batteries A, only batteries A of an equal number to the batteries B that are located in a temperature environment where charge and discharge need be stopped are charged or discharged. Therefore, each of the batteries A is efficiently charged and discharged.

In addition, according to the present embodiment, after the use of the storage battery 2 is started and before a first determination based on the temperature threshold Tth is carried out, the controller 10 stops the charge and the discharge of all of the batteries (the second batteries) B. Actually, the storage battery 2 in which the aforementioned charge and discharge control is performed is low in temperature at the time of and immediately after the start of use of the storage battery 2. Thus, since the charge and the discharge of all of the batteries B are stopped at the time of and immediately after the start of use of the storage battery 2, the precipitation of lithium metal in the negative electrode of each of the batteries B can be prevented more efficiently. Accordingly, the safety is further improved when the storage battery 2 is charged with a large current under a low-temperature environment or the like.

### Modification of Second Embodiment

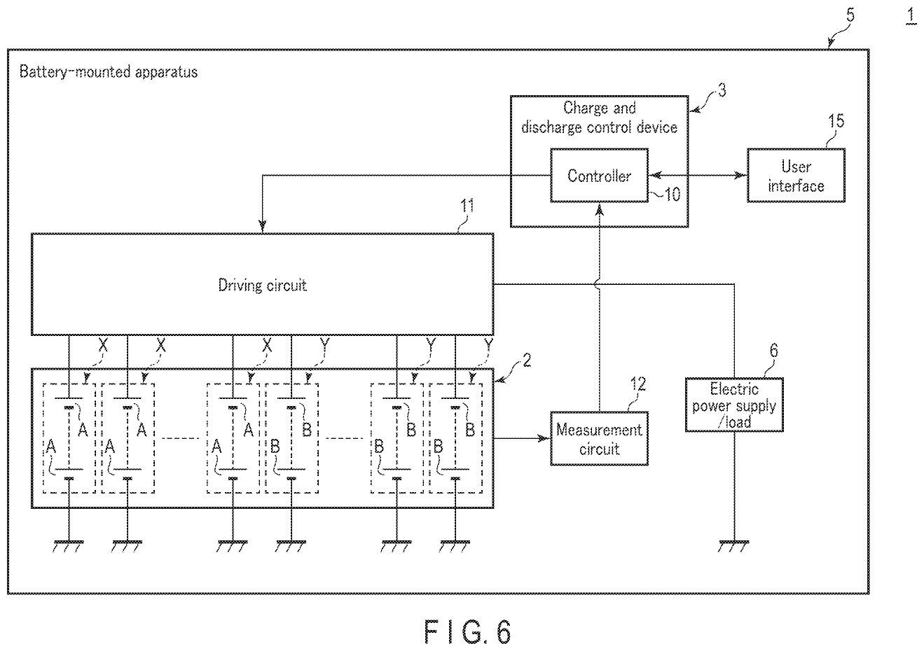

In a modification of the second embodiment, as shown in FIG. 6, a storage battery 2 includes a plurality of battery modules (first battery modules) X and a plurality of battery modules (second battery modules) Y. In each of the battery modules X, a plurality of batteries (first batteries) A are electrically connected in series, and each battery module X is formed of a batteries A. In each of the battery modules Y, a plurality of batteries (second batteries) B are electrically connected in series, and each battery module Y is formed of a batteries B. Thus, the number of the batteries A in each battery module X is the same as the number of the batteries B in each battery module Y.

In the present modification, the battery modules X are controlled independently of each other regarding charge and discharge, and the battery modules Y are controlled independently of each other regarding charge and discharge. Therefore, the controller 10 can charge or discharge only some of the battery modules X, and stop the charge and the discharge of the remainders of the battery modules X by controlling driving of the driving circuit 11. Similarly, the controller 10 can charge or discharge only some of the battery modules Y, and stop the charge and the discharge of the remainders of the battery modules Y by controlling driving of the driving circuit 11. However, each of the battery modules X can be switched only between a state in which charge and discharge are performed in all of the α batteries A and a state in which the charge and the discharge are stopped in all of the a batteries A. Similarly, each of the battery modules Y can be switched only between a state in which charge and discharge are performed in all of the α batteries B and a state in which the charge and the discharge are stopped in all of the α batteries B.

Furthermore, in this modification, the measurement circuit 12 measures a temperature Ty of each of the battery modules Y as parameters relating to the storage battery 2. For examples, the measurement circuit 12 includes temperature sensors of an equal number to the number of the battery modules Y; thus, the temperatures Ty of all of the battery modules Y are measured by the temperature sensors. The controller 10 periodically acquires measurement results of the temperature Ty of each of the battery modules Y. In this modification, the measurement value of the temperature Ty is defined as a temperature Tb of the α batteries B in each of the battery modules Y. Therefore, in this modification, the controller 10 performs processing on the assumption that the temperature Tb of the α batteries in each of the battery modules Y is the same as the temperature Ty.

In this modification, the controller 10 determines whether, of the battery modules Y, there is a battery module Y having a temperature Ty acquired by the controller 10 that is lower than the temperature threshold Tth. In addition, after the use of the storage battery 2 is started and before a first determination based on the temperature threshold Tth is carried out, the controller 10 maintains a state in which all of the battery modules X are charged or discharged and the charge and the discharge of all of the battery modules Y are stopped. Therefore, not only in the second embodiment etc. but also in this modification, after the use of the storage battery 2 is started and before a first determination based on the temperature threshold Tth is carried out, the charge and the discharge of all of the batteries (the second batteries) B are stopped and all of the batteries (the first batteries) A are charged or discharged.

Furthermore, in this modification, if there is no battery module Y having a temperature Ty lower than the temperature threshold Tth, the controller 10 causes all of the battery modules Y to charge or discharge, and stops the charge and the discharge of all of the battery modules X. Therefore, as in the second embodiment etc., if there is no battery B having a temperature Tb lower than the temperature threshold Tth, the controller 10 causes all of the batteries (the second batteries) B to charge or discharge, and stops the charge and the discharge of all of the batteries (the first batteries) A.

If there are one or more battery modules Y having a temperature Ty lower than the temperature threshold Tth, the controller 10 acquires the number M of the battery modules Y having a temperature Ty lower than the temperature threshold Tth. Then, the controller 10 causes the battery modules X only of the number M to charge or discharge. If there are one or more battery modules Y having a temperature Ty lower than the temperature threshold Tth, the controller 10 stops the charge and the discharge of the M battery modules Y having a temperature Ty lower than the temperature threshold Tth, and causes the remainders of the battery modules Y having a temperature Ty equal to or higher than the temperature threshold Tth to charge or discharge.

Thus, in this modification, if there are one or more batteries (second batteries) B having a temperature Tb lower than the temperature threshold Tth, the charge and the discharge are stopped in some or all (α×M) of the batteries B. Then, of all batteries (the first batteries) A, the batteries A of an equal number (α×M) to that of the batteries (the second batteries) B in which the charge and the discharge are stopped are charged or discharged. As a result of the processing as described above, the present modification also exhibits similar effects and advantages to those of the second embodiment etc.

In at least one of the embodiments or modifications described above, the storage battery includes one or more first batteries that include a first active material as a negative electrode active material, and one or more second batteries that include a second active material having an operation electric potential lower than that of the first active material as a negative electrode active material. The charge and the discharge of the second batteries are stopped based on the fact that the temperature of the storage battery is lower than the temperature threshold. The second batteries are caused to charge or discharge based on the fact that the temperature is equal to or higher than the temperature threshold. As a result, it is possible to provide a charge and discharge control method, a charge and discharge control device, and a control system that assure a safety when the storage battery formed of two or more kinds of batteries is charged with a large current, and that allow discharge from the battery for a long period of time.

In at least one of the embodiments or modifications described above, the storage battery includes a plurality of first batteries that include a first active material as a negative electrode active material, and a plurality of second batteries that include a second active material having an operation electric potential lower than that of the first active material as a negative electrode active material. The charge and the discharge in each of the second batteries are stopped based on the fact that the temperature is lower than the temperature threshold. Each of the second batteries is caused to charge or discharge based on the fact that the temperature is equal to or higher than the temperature threshold. As a result, it is possible to provide a charge and discharge control method, a charge and discharge control device, and a control system that assure a safety when the storage battery formed of two or more kinds of batteries is charged with a large current, and that allow discharge from the battery for a long period of time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A charge and discharge control method of controlling charge and discharge of a storage battery, the storage battery including one or more first batteries that include a first active material as a negative electrode active material, and one or more second batteries that include a second active material having an operation electric potential lower than that of the first active material as a negative electrode active material, the method comprising:
stopping charge and discharge of the second batteries based on a fact that a temperature of the storage battery is lower than a temperature threshold; and
charging or discharging the second batteries based on a fact that the temperature of the storage battery is equal to or higher than the temperature threshold.

2. The charge and discharge control method according to claim 1, wherein:
if the temperature of the storage battery is lower than the temperature threshold, charge and discharge of the second batteries are stopped and only the first batteries are charged or discharged; and
if the temperature of the storage battery is equal to or higher than the temperature threshold, charge and discharge of the first batteries are stopped and only the second batteries are charged or discharged.

3. The charge and discharge control method according to claim 1, wherein:
the one or more second batteries of the storage battery are a plurality of second batteries;
the plurality of second batteries are configured to switch only between a state in which charge and discharge are performed in all of the plurality of second batteries and a state in which charge and discharge are stopped in all of the plurality of second batteries;
if the temperature of the storage battery is lower than the temperature threshold, charge and discharge of all of the plurality of second batteries are stopped; and
if the temperature of the storage battery is equal to or higher than the temperature threshold, all of the plurality of second batteries are charged or discharged.

4. The charge and discharge control method according to claim 1, further comprising:
acquiring, as the temperature of the storage battery, one of a measurement value of a temperature at one point in the storage battery, a lowest value of measurement values of temperatures at a plurality of points in the storage battery, and an average value or an intermediate value of measurement values of temperatures at a plurality of points in the storage battery.

5. A charge and discharge control device comprising:
a controller that executes the charge and discharge control method of claim 1, thereby controlling charge and discharge of the storage battery.

6. A control system, comprising:
the charge and discharge control device of claim 5; and
the storage battery, in which charge and discharge are controlled by the controller of the charge and discharge control device.

7. The control system according to claim 6, further comprising:
a battery-mounted apparatus on which the storage battery is mounted.

8. A battery-mounted apparatus comprising:
the charge and discharge control device of claim 5; and
the storage battery, in which charge and discharge are controlled by the controller of the charge and discharge control device.

9. A charge and discharge control method of controlling charge and discharge of a storage battery, the storage battery including a plurality of first batteries that include a first active material as a negative electrode active material, and a plurality of second batteries that include a second active material having an operation electric potential lower than that of the first active material as a negative electrode active material, the method comprising:
stopping charge and discharge of each of the plurality of second batteries based on a fact that a temperature is lower than a temperature threshold; and
charging or discharging each of the plurality of second batteries based on a fact that the temperature is equal to or higher than the temperature threshold.

10. The charge and discharge control method according to claim 9, further comprising:
charging or discharging, out of the plurality of first batteries, only first batteries of an equal number to that of the second batteries in which charge and discharge are stopped.

11. The charge and discharge control method according to claim 9, further comprising:
stopping charge and discharge of all of the plurality of first batteries, if the temperature is equal to or higher than the temperature threshold in all of the plurality of second batteries.

12. The charge and discharge control method according to claim 9, wherein:
the plurality of second batteries are controlled independently of each other regarding charge and discharge; and
out of the plurality of second batteries, in some or all of the second batteries in which the temperature is lower than the temperature threshold, charge and discharge are stopped.

13. A charge and discharge control device comprising:
a controller that executes the charge and discharge control method of claim 9, thereby controlling charge and discharge of the storage battery.

14. A control system comprising:
the charge and discharge control device of claim 13; and
the storage battery, in which charge and discharge are controlled by the controller of the charge and discharge control device.

15. The control system according to claim 14, further comprising:
a battery-mounted apparatus on which the storage battery is mounted.

16. A battery-mounted apparatus comprising:
the charge and discharge control device of claim 13; and
the storage battery, in which charge and discharge are controlled by the controller of the charge and discharge control device.
